(19) United States
(12) Patent Application Publication
(10) Pub. No.: US 2009/0102646 A1
(43) Pub. Date: Apr. 23, 2009

(54) DEVICE FOR IDENTIFYING AND PROTECTING AN ELEMENT WHOSE INTEGRITY IS DESIRED TO BE KNOWN

(76) Inventors: Nicolas Bara, La Villetertre (FR); Bruno Lo-Re, Saint-Maur-Des-Fosses (FR)

Correspondence Address: BLANK ROME LLP, WATERGATE, 600 NEW HAMPSHIRE AVENUE, N.W., WASHINGTON, DC, 20037, US

(21) Appl. No.: 12/091,007

(22) PCT Filed: Oct. 19, 2006
(86) PCT No.: PCT/FR2006/002350

§ 371 Date: Sep. 29, 2008

(30) Foreign Application Priority Data
Oct. 19, 2005 (FR) 0510647

(51) Int. Cl. G08B 21/00; H04B 7/00

(52) U.S. Cl. 340/540; 340/10.1

(57) ABSTRACT

The invention relates to an identifying and protecting device associated with an element whose integrity is desired to be known. The identifying and protecting device includes an electronic identification label assigned to a first antenna which is used for remotely reading the content of the label, a second antenna which is connected to the first antenna, and which is used for remotely reading the content of the label and is associated with the element in such a way that the coupling between the first and second antennas is broken when the integrity of the element is affected.

The invention relates to an identifying and protecting device designed for being connected to an element whose integrity is desired to be known, as well as an identifying and protecting assembly comprising such a device and a system for reading/writing such a device.

The invention relates to the field of identification by electronic tags whose contents can be read remotely, in particular RFID tags. Such tags are used in numerous contactless identification applications, such as access control (identification badges), ticketing (transport tickets), state security (passports), identification of samples or containers, etc. Tags can contain information including, for example, origin information, dates, contents, etc. The identifying tag tends in particular to replace the barcode as an identification means.

The tag is connected to an antenna for remotely reading the contents of the tag by means of a remote reading device.

In certain applications, it is desirable to know the integrity of the element bearing the identification tag, which is to say, it is desirable to know whether this element has been tampered with, for example to know whether a container containing a sample was opened and then resealed.

Physical means such as a safety tape can be used to verify this integrity. However, it may be useful to obtain this information in the reading device without having to physically check the element bearing the identification tag.

It is known to place the antenna on the element bearing the tag in such a way that this antenna breaks when the element is tampered with. In this way, when the integrity of the element is no longer guaranteed, the contents of the tag cannot be read, since the antenna is no longer capable of emitting information, meaning that the element has been opened.

However, this type of system prevents subsequent reading of the tag. The tag is therefore rendered unusable and the information it contained is no longer readable. And yet, the information contained in the tag is still useful, even though the element has been tampered with.

The invention aims to solve these disadvantages by providing an identifying and protecting device comprising two antennas coupled with one another, both antennas allowing the contents of the tag to be read and one of the antennas informing on whether or not the element has been tampered with by breakage or separation of this antenna.

For this purpose and according to a first aspect, the invention relates to an identifying and protecting device designed for being connected to an element whose integrity is desired to be known, said device comprising an RFID tag connected to a first antenna arranged to allow remote reading of the tag contents, said device comprising at least one second antenna coupled with the first antenna, said second antenna being designed for being connected to the element so that the coupling between the first and second antennas is broken when said element is tampered with.

Thus, when the information contained in the tag can be read by means of the second antenna and the first antenna, this means that the element has not been tampered with. On the other hand, when the information is read by means of the first antenna only, this means that the element has been tampered with. In either case, the tag can still be read and the information it contains is not lost.

According to one embodiment, the coupling is broken by opening the second antenna when the element is tampered with. In this case, the coupling is broken for good.

According to a variation on this embodiment, the opening of the second antenna is a breakage of said antenna when the element is tampered with.

According to other alternative embodiments, the second antenna is opened by a deterioration of said antenna caused by the surrounding medium, for example, deterioration of the antenna after certain time or when a pre-defined temperature is exceeded.

According to another embodiment, the coupling is broken by separating the second antenna from the first antenna when tampering with the element. In this case, the breakage of the coupling is reversible; it is possible to restore the coupling by bringing the second antenna close to the first antenna.

The first and second antennas can be coupled electromagnetically without contact between said antennas.

According to a second embodiment, the invention relates to an identifying and protecting assembly such as described above as well as to a system for reading/writing said device, said system comprising a first read head arranged to read the signal emitted by the first antenna and at least one second read head arranged to read the signal emitted by the second antenna, said system being arranged to emit a positive signal if the signals are read from both antennas and a negative signal if the signals are read from the first antenna only.

Other advantages and special features of the invention will become apparent from the following description, made in reference to the appended drawings.

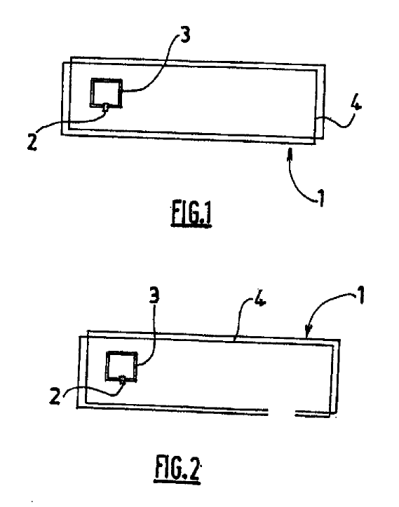

FIG. 1 is a diagrammatic representation of an identifying and protecting device according to the invention, the element being intact.

FIG. 2 is a diagrammatic representation of the device of FIG. 1 when the element has been tampered with.

In reference to FIG. 1, an identifying and protecting device 1 is described, designed for being connected to an element (not shown) whose integrity is desired to be known.

For the sake of simplicity, the device 1 is described connected to an element whose state of integrity consists of knowing whether or not the element has been opened.

The device 1 comprises an electronic identification tag 2 whose contents can be read remotely. The tag 2 is, for example, an RFID tag. A battery can be connected to the tag to power it, in which case it is called an active tag. According to another embodiment, the tag 2 can be powered by the remote reading device arranged to read the contents of the tag. In this case, the tag is not connected to a battery and the tag is said to be passive.

The tag 2 is connected to a first antenna 3. The first antenna 3 is arranged so that the contents of the tag 2 can be read remotely by a reading device. Likewise, contents can be written to the tag 2 by means of a reading device, which in this case is a reading/writing device.

The first antenna 3 is, for example, electrically connected to the tag 2, which is to say that an electrical connection exists between the antenna 3 and the tag 2. According to another embodiment, the antenna 3 can be contactlessly coupled with the tag 2 by means of electromagnetic coupling.

The first antenna 3 is placed near the tag 2 on one of the parts of the element that remains intact if the element is opened. For example, in the case of a container comprising a body and a lid, the tag 2 and the first antenna 3 are arranged entirely on the body of the container. In this way it is possible to guarantee that the contents of the tag 2 will always be readable, even when the element has been tampered with. The first antenna can have various shapes according to the embodiments and the geometrical constraints of the element to which the element 1 is designed to be connected.

The device 1 also comprises a second antenna 4 coupled with the first antenna 3. According to the embodiment shown in the figures, the second antenna 4 is electromagnetically coupled with the first antenna 3, which is to say that there is no electrical contact between the first and second antennas. Electromagnetic coupling consists of matching and creating resonance between two antennas in order to transmit an electromagnetic modulation representing the contents of the tag 2.

The second antenna 4 is designed to be arranged at least partially on the part of the element which can be tampered with. Thus, in the case of the element comprising a container body and a lid, the second antenna 4 extends at least partially across the lid. The second antenna 4 can have various shapes according to the embodiments and the geometrical constraints of the element. One shape constraint is that it is also necessary to guarantee electromagnetic coupling with the first antenna 3.

According to the embodiment shown in the figures, the second antenna 4 surrounds the first antenna 3 and is much larger than the first antenna 3.

In normal operation, when the element has not been opened and has not been tampered with, the contents of the tag 2 can be read by means of the second antenna 4 and/or the first antenna 3. In this way, additional information is obtained indicating that the element is intact.

According to the embodiment shown in the figures, when the second antenna 4 only extends partially across the part of the element which can be tampered with, the second antenna 4 is arranged to break, as shown in FIG. 2, when the element is tampered with. In this way, when the element has been opened, the contents of the tag 2 can only be read by means of the first antenna 3, the second antenna 4 having broken and not working. In this way, additional information is obtained indicating that the element has been tampered with.

In addition to the breakage of the second antenna 4 it is possible according to the embodiments for the second antenna 4 to open by deterioration of the material from which the antenna 4 is made. Thus, if the integrity information consists of knowing whether the element was kept within a given temperature range during its storage, the antenna 4 can be made from a material that deteriorates if a pre-defined temperature is exceeded. A material suitable for such use is then chosen. If the integrity information consists on knowing whether an expiry date has passed, the antenna 4 can be made from a material that deteriorates after a certain time matching this expiry date. Likewise, the antenna can be made from other materials 4 according to what needs to be known about the integrity of the element, for example, an antenna that deteriorates or stops emitting in aqueous, acid or basic environments, etc.

According to another embodiment, when the second antenna 4 extends across the entirety of the part of the element which can be tampered with, for example a lid which can be opened or closed, the second antenna 4 separates from the first antenna 3 and the tag 2 when the element is open. The electromagnetic coupling between the two antennas is then broken and the contents of the tag 2 can only be read by means of the first antenna 3. This provides additional information indicating that the element has been tampered with.

In any case, the contents of the tag 2 can still be read by means of the first antenna and these contents are not lost when the element is tampered with.

According to other embodiments, it is possible to provide other antennas in addition to the second antenna 4. These antennas are coupled with one another and arranged for the coupling to be broken as indicated above if the element is tampered with. It is possible, for example, to provide an antenna which deteriorates according to temperature coupled with an antenna arranged to break if the element is opened, etc.

The following describes an identifying and protecting assembly such as described above and a reading/writing system for this device. The reading/writing system comprises a first read head arranged to read the signal emitted by the first antenna 3. The system additionally comprises at least one second read head arranged to read the signal emitted by the second antenna 4. The device can thus simultaneously read the signal emitted by the first antenna 3 and that emitted by the second antenna 4. The system is designed to emit a positive signal when the signals are read from the two antennas and a negative signal if the signals are read from the first antenna 3 only. The positive signal is, for example, a diode that lights up when the two signals are read and the negative signal is a diode that does not light up. The signal emitted by the system can also be transferred to a processing system.

According to one embodiment, the system is arranged to transmit the positive or negative signal to the tag 2 by means of a write head, in order to write the integrity information to this tag.

1. An identifying and protecting device designed for being connected to an element whose integrity is desired to be known, said device comprising an electronic identification tag (2) connected to a first antenna (3) arranged to allow contents of the tag (2) to be read remotely, said device further comprising at least one second antenna (4) coupled with the first antenna (3), said second antenna being arranged to allow the contents of the tag (2) to be read remotely, said second antenna being designed for being connected to the element so that the coupling between the first (3) and second antennas (4) is broken when the element is tampered with.

2. The identifying and protecting device according to claim 1, wherein the tag (2) and the first antenna (3) are designed to be arranged on a part of the element whose integrity is always preserved, the second antenna (4) extending at least partially across the part of the element that can be tampered with.

3. The identifying and protecting device according to claim 1, wherein the coupling is broken by opening the second antenna (4) when tampering with the element.

4. The identifying and protecting device according to claim 3, wherein the second antenna (4) is opened by breaking said antenna.

5. The identifying and protecting device according to claim 3, wherein the second antenna (4) is opened by the deterioration of the material of said antenna according to the nature of the surrounding medium.

6. The identifying and protecting device according to claim 1, wherein the coupling is broken by separation between the second antenna (4) and the first antenna (3) when the element is tampered with, the coupling between the antennas being restored by bringing said antennas close together.

7. The identifying and protecting device according to claim 1, wherein the first (3) and second (4) antennas are electromagnetically coupled with no contact between said antennas.

8. The identifying and protecting device according to claim 1, wherein the contents of the tag (2) are read by means of the second antenna (4) and/or the first antenna (3) when the element has not been tampered with and by means of the first antenna (3) only when said element has been tampered with.

9. The identifying and protecting device according to claim 1 wherein the electronic identification tag (2) is connected to a battery powering said tag.

10. The identifying and protecting device according to claim 1, wherein the electronic identification tag (2) is powered by the remote reading device arranged to read the contents of the tag.

11. An identifying and protecting assembly comprising an identifying and protection device according to claim 1, said assembly further comprising a system for reading/writing said device, said system comprising a first read head arranged to read the signal emitted by the first antenna (3) and at least one second read head arranged to read the signal emitted by the second antenna (4), said system being arranged to emit a positive signal if the signals are read on the two antennas and a negative signal if the signals are read on the first antenna (3) only.

12. The identifying and protecting assembly according to claim 11, wherein the system is arranged to transmit the positive or negative signal to the tag (2) by means of a write head, in order to write the integrity information to said tag.

13. The identifying and protecting device according to claim 2, wherein the coupling is broken by opening the second antenna (4) when tampering with the element.

14. The identifying and protecting device according to claim 2, wherein the coupling is broken by separation between the second antenna (4) and the first antenna (3) when the element is tampered with, the coupling between the antennas being restored by bringing said antennas close together.

15. The identifying and protecting device according to claim 2, wherein the first (3) and second (4) antennas are electromagnetically coupled with no contact between said antennas.

16. The identifying and protecting device according to claim 2, wherein the contents of the tag (2) are read by means of the second antenna (4) and/or the first antenna (3) when the element has not been tampered with and by means of the first antenna (3) only when said element has been tampered with.

17. The identifying and protecting device according to claim 2, wherein the electronic identification tag (2) is connected to a battery powering said tag.

18. The identifying and protecting device according to claim 2, wherein the electronic identification tag (2) is powered by the remote reading device arranged to read the contents of the tag.
